(19) United States
(12) Patent Application Publication
(10) Pub. No.: US 2009/0154511 A1
(43) Pub. Date: Jun. 18, 2009

(54) OPTICAL OUTPUT CONTROL CIRCUIT AND OPTICAL OUTPUT MONITORING METHOD FOR MONITORING OPTICAL OUTPUT FROM LASER LIGHT SOURCE

(76) Inventor: Munetoshi Yoshizawa, Tokyo (JP)

Correspondence Address: NEC CORPORATION OF AMERICA, 6535 N. STATE HWY 161, IRVING, TX, 75039, US

(21) Appl. No.: 12/332,632

(22) Filed: Dec. 11, 2008

(30) Foreign Application Priority Data
Dec. 13, 2007 (JP) 2007-322407

(51) Int. Cl. H01S 3/13

(52) U.S. Cl. 372/29.011

(57) ABSTRACT

A Light receiver generates a monitoring voltage according to an optical output of an LD element. The control circuit obtains a set value according to the ambient temperature around the LD element, and controls the optical output of the LD element on the basis of the comparing the result between the set value and the monitoring voltage. An adjustment section corrects the monitoring voltage on the basis of the set value and outputs the corrected monitoring voltage.

This application is based upon and claims the benefit of priority from Japanese patent application No. 2007-322407, filed on Dec. 13, 2007, the disclosure of which is incorporated herein in its entirety by reference.

### BACKGROUND OF THE INVENTION

1. Field of the Invention

The present invention relates to an optical output control circuit and to an optical output monitoring method.

2. Description of the Related Art

In general, a laser output apparatus using a laser light source such as a LD (laser diode) element has an optical output control circuit for stabilizing the optical output from the laser light source.

FIG. 1 is a circuit diagram showing the configuration of an optical transmitter having an optical output control circuit.

Referring to FIG. 1, drive circuit 101 supplies drive current 102 to LD element 103. LD element 103 produces laser oscillation by drive current 102 to generate forward light output 104 and backward light output 105.

Monitoring PD (photodiode) 106 generates photocurrent 107 according to backward light output 105. Photocurrent 107 is converted into monitoring voltage 109 by means of resistor 108. Automatic power control (APC) circuit 110 controls drive current 102 supplied by drive circuit 101 so that the value of monitoring voltage 109 becomes equal to set value 111.

Forward light output 104 is coupled to optical fiber 112 and is output as optical output 113 from optical fiber 112.

Changes occur, for example, in the ratio of forward light output 104 and backward light output 105 and in the efficiency of coupling between forward light output 104 and optical fiber 112 with a change in the ambient temperature occurring around LD element 103. Such changes are generally called a tracking error.

Because a tracking error occurs, forward light output 104 and optical output 113 change even when APC circuit 110 controls monitoring voltage 109 at set value 111, although backward light output 105 is made constant by this control.

Tracking error correction circuit 114 corrects the tracking error. More specifically, tracking error correction circuit 114 adjusts set value 111 on the basis of the ambient temperature around LD element 103 to make forward light output 104 or optical output 113 constant even when the ambient temperature changes.

A semiconductor laser control circuit capable of correcting a tracking error without using tracking error correction circuit 114 is described in Japanese Patent Laid-Open No. 2003-101131.

This semiconductor laser control circuit first determines the factor of amplification of a monitoring voltage on the basis of a reference temperature signal and a drive voltage converted from a drive current for a semiconductor laser by a resistor. The reference temperature signal is a drive voltage such that the optical output from the semiconductor laser at the reference temperature is a constant value.

The semiconductor laser control circuit then amplifies the monitoring voltage by the determined amplification factor to generate an emission level monitoring signal. The semiconductor laser control circuit controls the semiconductor laser drive current so that the emission level monitoring signal equals an emission level control signal representing the optical output from the semiconductor laser.

When the optical output from the semiconductor laser is a constant value, the semiconductor laser control circuit determines the monitoring voltage amplification factor so that the emission level monitoring signal equals the emission level control signal.

It is, therefore, possible to make the optical output constant even when the ambient temperature around the semiconductor laser changes. Thus, the optical output can be made constant even when a tracking error occurs.

In either case, the optical output from the laser light source can be monitored if the optical output control circuit outputs the monitoring voltage to an external point.

In the optical output control circuit shown in FIG. 1, however, set value 111 changes with the ambient temperature around LD element 103 and, therefore, the value of monitoring voltage 109 changes even when forward light output 104 or optical output 113 is constant. For this reason, it is difficult to know the value of forward light output 104 or optical output 113 with accuracy even though monitoring voltage 109 is output. Thus, there is a problem in which it is difficult to monitor the optical output with accuracy.

In the semiconductor laser control circuit described in Japanese Patent Laid-Open No. 2003-101131, when the optical output from the semiconductor laser is constant, the emission level monitoring signal does not change even if the ambient temperature around the semiconductor laser changes. Therefore, the optical output can be monitored with accuracy.

In this semiconductor laser control circuit, however, the monitoring voltage is amplified by using the semiconductor laser drive voltage, aside from the emission level control signal for controlling the optical output of the semiconductor laser. Therefore, a circuit for detecting the drive voltage is required and the entire circuit becomes complicated.

### SUMMARY OF THE INVENTION

An object of the present invention is to provide an optical output control circuit and an optical output monitoring method as a solution to the above-described problem in which the circuit is complicated.

The present invention provides an optical output control circuit which monitors the optical output of a laser light source, and which includes a light receiver, a controller and an adjustor.

The light receiver generates a monitoring voltage according to the optical output.

The controller obtains a set value according to the ambient temperature around the laser light source, and controls the optical output of the laser light source on the basis of comparing the results between the set value and the monitoring voltage.

The adjustor corrects the monitoring voltage on the basis of the set value and outputs the corrected monitoring voltage.

The present invention also provides an optical output monitoring method including generating a monitoring voltage according to the optical output of a laser light source, generating a set value according to the ambient temperature around the laser light source, controlling the optical output of the laser light source on the basis of the result of comparison between the set value and the monitoring voltage, and correcting the monitoring voltage on the basis of the set value and outputting the corrected monitoring voltage.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a circuit diagram showing the configuration of an optical transmitter according to a related art;

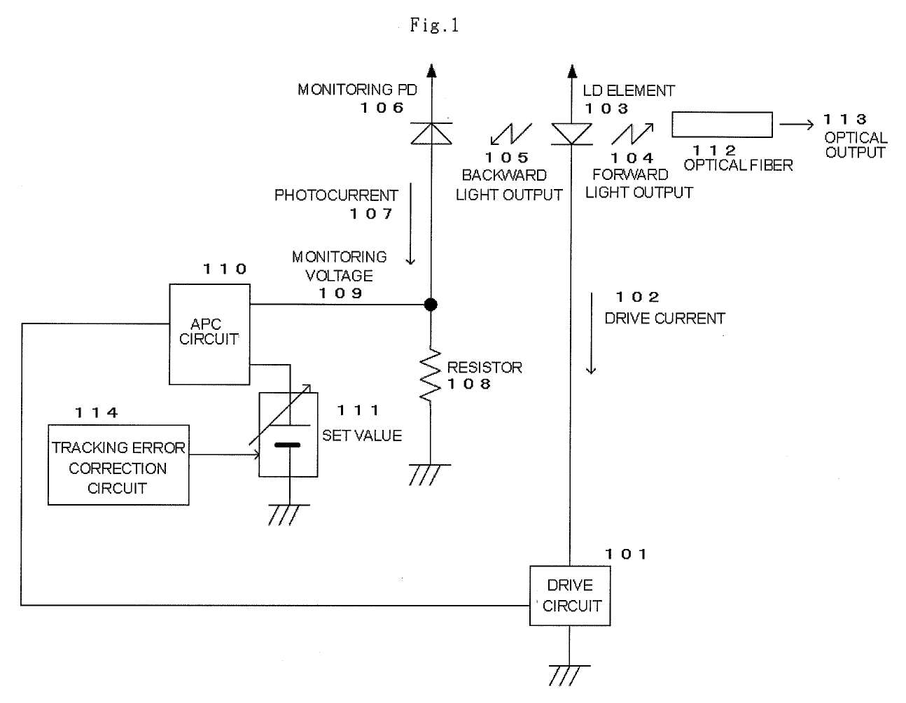

FIG. 2 is a circuit diagram showing the configuration of an optical transmitter according to a first embodiment;

FIG. 3 is a circuit diagram showing the configuration of an optical transmitter according to a second embodiment; and

FIG. 4 is a circuit diagram showing the configuration of an optical transmitter according to a third embodiment.

### DETAILED DESCRIPTION OF THE PREFERRED EMBODIMENTS

Exemplary embodiments will be described with reference to the accompanying drawings.

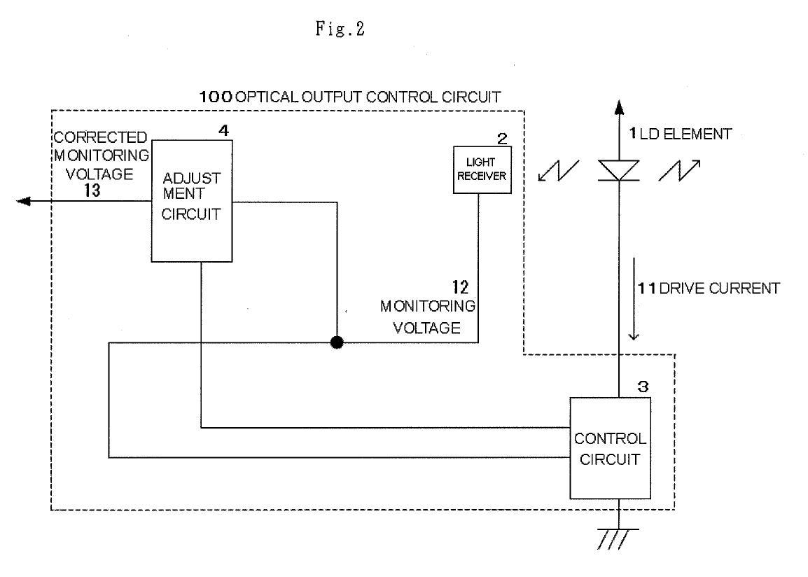

FIG. 2 is a circuit diagram showing an optical transmitter according to the first exemplary embodiment.

Referring to FIG. 2, the optical transmitter includes LD element 1 and optical output control circuit 100.

LD element 1 is an example of a laser light source. LD element 1 produces laser oscillation by drive current 11 to output a laser ray as an optical output.

Optical output control circuit 100 monitors the optical output from LD element 1. More specifically, optical output control circuit 100 includes Light receiver 2, control circuit 3, and adjustment circuit 4, and each section performs processing described below.

Light receiver 2 generates monitoring voltage 12 according to the optical output from LD element 1.

Control circuit 3 obtains a set value according to the ambient temperature around LD element 1. The set value is the value of monitoring voltage 12 when the optical output of LD element 1 is a predetermined value.

Control circuit 3 controls the optical output of LD element 1 on the basis of the result of comparison between the set value and monitoring voltage 12. More specifically, control circuit 3 controls the optical output of LD element 1 by comparing the value of monitoring voltage 12 and the set value and controlling the value of drive current 11 so that the value of monitoring voltage 12 and the set value become equal to each other.

Adjustment circuit 4 corrects monitoring voltage 12 on the basis of the set value obtained by control circuit 3 and outputs corrected monitoring voltage 13.

For example, adjustment circuit 4 multiplies monitoring voltage 12 by the reciprocal of the set value (1/(set value)) and outputs the corrected monitoring voltage. Since the value of monitoring voltage 12 is controlled by control circuit 3 so as to be equal to the set value, the value of corrected monitoring voltage 13 obtained by multiplying the monitoring voltage by the reciprocal of the set value is a constant value “1”.

The above-described example of the method of generating corrected monitoring voltage 13 is not exclusively used, and a different method may alternatively be used as desired. For example, adjustment circuit 4 may subtract the value of the monitoring voltage from the sum of a predetermined value and the set value.

The operation will now be described.

Control circuit 3 measures the ambient temperature around LD element 1 and obtains a set value according to the ambient temperature. The relationship between the ambient temperature and the set value is determined in advance according to the characteristics of LD element 1 for example.

Control circuit 3 generates a set voltage of the set value.

LD element 1 produces laser oscillation by drive current 11 to generate an optical output.

Light receiver 2 receives the optical output and generates monitoring voltage 12 according to the optical output.

Control circuit 3 accepts monitoring voltage 12 generated in light receiver 2. Control circuit 3 compares the value of monitoring voltage 12 and the set value and controls the value of drive current 11 so that the value of monitoring voltage 12 and the set value become equal to each other.

Adjustment circuit 4 accepts monitoring voltage 12 generated in light receiver 2 and the set voltage generated in control circuit 3. Adjustment circuit 4 corrects monitoring voltage 12 on the basis of the set value of the set voltage and outputs corrected monitoring voltage 13. For example, adjustment circuit 4 multiplies monitoring voltage 12 by the ratio of a reference value and the set value and outputs corrected monitoring voltage 13.

The effects will now be described.

In the present exemplary embodiment, light receiver 2 generates monitoring voltage 12 according to the optical output of LD element 1. Control circuit 3 obtains a set value according to the ambient temperature around LD element 1. Control circuit 3 controls the optical output of LD element 1 on the basis of the result of comparison between the set value and monitoring voltage 12. Adjustment circuit 4 corrects monitoring voltage 12 on the basis of the set value and outputs corrected monitoring voltage 13.

In this case, the optical output of LD element 1 is controlled on the basis of comparing the result between the set value and monitoring voltage 12. Also, monitoring voltage 12 is corrected on the basis of the set value.

Therefore, the optical output can be monitored with accuracy without detecting the drive voltage. As a result, the circuit can be simplified.

A second exemplary embodiment will now be described.

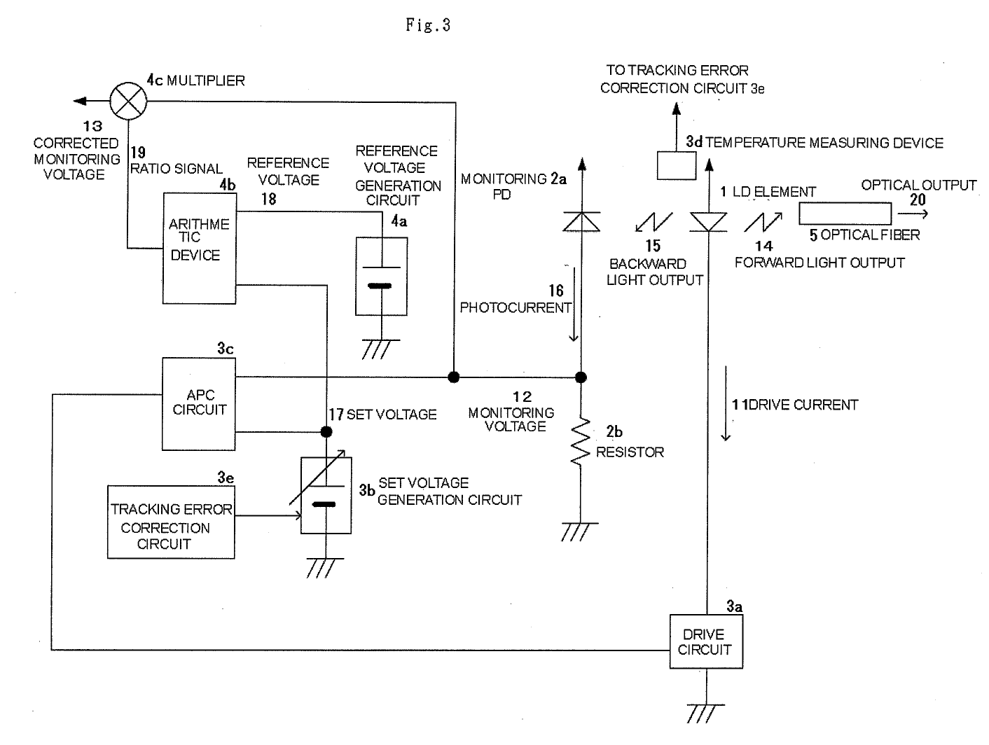

FIG. 3 is a circuit diagram showing the configuration of an optical transmitter according to the second exemplary embodiment. In FIG. 3, the same components as those shown in FIG. 2 are indicated by using the same reference characters.

Referring to FIG. 3, the optical transmitter includes LD element 1, monitoring PD 2a, resistor 2b, drive circuit 3a, set voltage generation circuit 3b, APC circuit 3c, temperature measuring device 3d, tracking error correction circuit 3e, reference voltage generation circuit 4a, arithmetic device 4b, and multiplier 4c.

The optical output of LD element 1 includes forward light output 14 from an optical-fiber-side end surface and backward light output 15 from a monitoring-PD-side end surface. Forward light output 14 is an example of the first optical output, while backward light output 15 is an example of the second optical output.

Forward light output 14 is optically coupled to optical fiber 5 and is output as optical output 20 from optical fiber 5.

Monitor PD 2a and resistor 2b constitute light receiver 2 shown in FIG. 2.

Light receiver 2 receives the backward light output and generates monitoring voltage 12. More specifically, monitoring PD 2a receives backward light output 15 and generates a current according to backward light output 15 (hereinafter referred to as photocurrent 16). Photocurrent 16 is converted into monitoring voltage 12 by means of resistor 2b.

Drive circuit 3a, set voltage generation circuit 3b, APC circuit 3c, temperature measuring device 3d and tracking error correction circuit 3e constitute the control circuit 3 shown in FIG. 2.

Drive circuit 3a supplies drive current 11 to LD element 1. The value of drive current 11 is controlled by APC circuit 3c.

Set voltage generation circuit 3b generates set voltage 17 that has a set value. The set value is adjusted in tracking error correction circuit 3e.

APC circuit 3c controls the value of drive current 11 supplied by drive circuit 3a so that the value of monitoring voltage 12 becomes equal to the set value.

More specifically, APC circuit 3c compares the value of monitoring voltage 12 and the set value and outputs a control signal according to the result of this comparison to drive circuit 3a. For example, APC circuit 3c outputs a high-level signal when the value of the monitoring voltage is higher than the value of the set voltage, and outputs a low-level signal when the value of the monitoring voltage is lower than the value of the set voltage. Drive circuit 3a reduces the value of drive current 11 if the control signal is a high-level signal, and increases the value of drive current 11 if the control signal is a low-level signal.

Temperature measuring device 3d measures the ambient temperature around LD element 1.

Tracking error correction circuit 3e obtains the set value according to the ambient temperature measured by temperature measuring device 3d. Tracking error correction circuit 3e adjusts the set value of set voltage 17 generated by set voltage generation circuit 3b.

Reference voltage generation circuit 4a, arithmetic device 4b and multiplier 4c constitute adjustment circuit 4 shown in FIG. 2.

In the present exemplary embodiment, adjustment circuit 4 corrects monitoring voltage 12 on the basis of the set value and a predetermined reference value which is a set value according to a reference temperature, and outputs corrected monitoring voltage 13. The reference value is an example of the reference set value.

Arithmetic device 4b obtains the ratio of the set value of set voltage 17 generated by set voltage generation circuit 3b and the reference value of reference voltage 18 generated by reference voltage generation circuit 4a.

Multiplier 4c multiplies monitoring voltage 12 by the ratio obtained by arithmetic device 4b and outputs corrected monitoring voltage 13.

Description will now be made of the value of corrected monitoring voltage 13. The reference value is assumed to be a set value at 25° C.

With respect to an ambient temperature of 25° C. around LD element 1, the corresponding set value is represented by Vset(25° C.) and an optical output 20 is represented by Pf(25° C.).

In this case, the ratio of the set value and the reference value is 1. Accordingly, the value of corrected monitoring voltage 13 is the same value as the set value, “Vset(25° C.)”.

It is assumed here that the ambient temperature changes to XOC; a tracking error occurs due to this change in the ambient temperature; and the amount of light in optical output 20 becomes Pf(X° C.).

In this case, tracking error correction circuit 3e enables maintenance of optical output 20 at Pf(25° C.) by adjusting the set value by multiplying the set value by Pf(25° C.)/Pf(X° C.). This can be achieved because the relationship between the set value and optical output 20 can be linearly approximated.

The value of monitoring voltage 12 coincides with the set value and is therefore multiplied by Pf(25° C.)/Pf(X° C.), as is the set value.

Arithmetic device 4b obtains the ratio of the set value and the reference value as Vset(X° C.)/reference value=Vset(X° C.)/Vset(25° C.)=Pf(X° C.)/Pf(25° C.).

Multiplier 4c multiplies monitoring voltage 12 by the ratio Pf(X° C.)/Pf(25° C.). As a result, the value of corrected monitoring voltage 13 is Vset(25° C.). That is, the value of corrected monitoring voltage 13 is constant even though the set value is changed.

The operation will now be described.

Forward light output 14 of LD element 1 is optically coupled to optical fiber 5 to be output as optical output 20.

Monitor PD 2a generates photocurrent 16 according to backward light output 15 of LD element 1. Photocurrent 16 is converted into monitoring voltage 12 by means of resistor 2b.

APC circuit 3c accepts monitoring voltage 12 converted by means of resistor 2b and set voltage 17 generated by set voltage generation circuit 3b. APC circuit 3c compares the value of monitoring voltage 12 and the set value of set voltage 17 and outputs the control signal according to the result of this comparison to drive circuit 3a. Drive circuit 3a accepts the control signal from APC circuit 3c and changes the value of drive current 11 according to the control signal.

Temperature measuring device 3d measures the ambient temperature around LD element 1 and the temperature signal that indicates the ambient temperature to tracking error correction circuit 3e. Tracking error correction circuit 3e accepts the temperature signal and obtains the set value according to the ambient temperature indicated by the temperature signal. Tracking error correction circuit 3e outputs the set value signal indicating the obtained set value to set voltage generation circuit 3b. Set voltage generation circuit 3b accepts the set value signal and adjusts the value of set voltage 17 to the set value indicated by the set value signal.

Arithmetic device 4b accepts set voltage 17 generated by set voltage generation circuit 3b and reference voltage 18 generated by reference voltage generation circuit 4a. Arithmetic device 4b obtains the ratio of the set value of set voltage 17 and the reference value of reference voltage 18. Arithmetic device 4b outputs ratio signal 19 that indicates the ratio to multiplier 4c.

Multiplier 4c accepts monitoring voltage 12 and ratio signal 19. Multiplier 4c multiplies monitoring voltage 12 by the ratio indicated by ratio signal 19 and outputs the multiplied monitoring voltage as corrected monitoring voltage 13.

The effects will now be described.

In the present exemplary embodiment, adjustment circuit 4 corrects monitoring voltage 12 on the basis of the reference value according to the predetermined reference temperature and the set value and outputs corrected monitoring voltage 13.

In this case, the reference value corresponds to the predetermined reference temperature, and the set value corresponds to the ambient temperature. Therefore the relationship between the reference value and the set value represents the difference between the reference temperature and the ambient temperature. As a result, the monitoring voltage can be corrected according to the difference between the predetermined temperature and the ambient temperature.

Since only setting of the reference value according to the reference temperature is made, the value of corrected monitoring voltage 13 can be easily adjusted.

In the present exemplary embodiment, arithmetic device 4b obtains the ratio of the set value and the reference value. Also, multiplier 4c multiplies monitoring voltage 12 by the ratio obtained by arithmetic device 4b and outputs corrected monitoring voltage 13.

Therefore, corrected monitoring voltage 13 that has a constant value when the optical output of the LD element 1 has a predetermined value can be easily generated even if the ambient temperature around LD element 1 varies. Also, the optical output of LD element 1 can be easily monitored because when the optical output of the LD element 1 has the predetermined value, the value of corrected monitoring voltage 13 equals the reference value.

In the present exemplary embodiment, light receiver 2 receives backward light output 15 in forward light output 14 and backward light output 15 of LD element 1 and generates monitoring voltage 12. Adjustment circuit 4 outputs corrected monitoring voltage 13 as a monitoring voltage corresponding to forward light output 14.

It is, therefore, possible to easily monitor forward light output 14 of LD element 1.

A third exemplary embodiment will now be described.

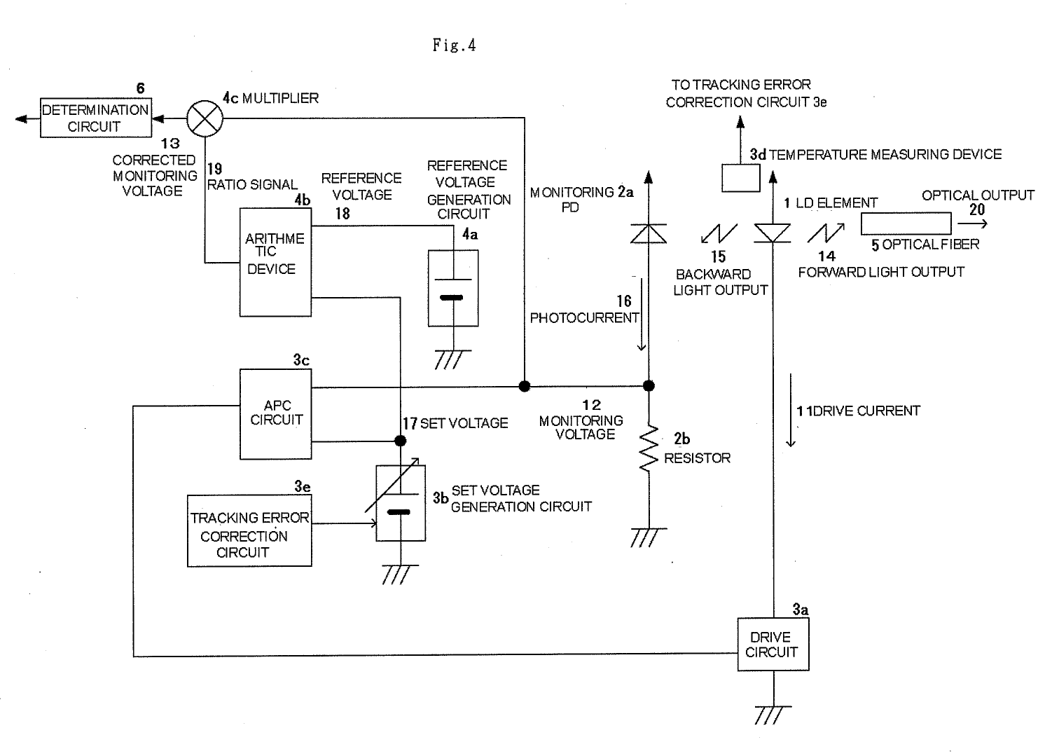

FIG. 4 is a circuit diagram showing the configuration of an optical transmitter according to the third exemplary embodiment. In FIG. 4, the same components as those shown in FIG. 3 are indicated by using the same reference characters. The description for the same components will not be repeated.

Referring to FIG. 4, the optical transmitter includes determination circuit 6 in addition to the configuration shown in FIG. 3.

Determination circuit 6 makes determination as to whether or not the value of corrected monitoring voltage 13 is larger than a predetermined threshold value, and outputs the result of this determination.

The effects will be described.

The optical output of LD element 1 may decrease due to degradation of LD element 1 or the like. In such a case, there is a possibility that the value of monitoring voltage 12 will not become the set value even when drive current 11 is controlled. Therefore, a reduction in optical output can be detected by determining as to whether or not the value of monitoring voltage 12 is larger than a threshold value.

However, the value of monitoring voltage 12 changes according to the ambient temperature around LD element 1 even when the optical output does not become lower. Therefore, there has been a need set the threshold value lower in advance. For example, the threshold value is set to a value that is approximately the minimum of the set value. Therefore, it has been a difficult to detect a reduction in optical output at an early stage.

In the present exemplary embodiment, determination circuit 6 determines whether or not the value of corrected monitoring voltage 13 is larger than the threshold value and outputs the determination result.

In this case, the value of corrected monitoring voltage 13 does not change with the change in ambient temperature around LD element 1 and, therefore, there has been no need to set the threshold value lower in advance. Detection of a reduction in optical output at an early stage is thus enabled.

While preferred embodiments of the present invention have been described using specific terms, such description is for illustrative purposes only, and it is to be understood that changes and variations may be made without departing from the spirit or scope of the following claims.

What is claimed is:

1. An optical output control circuit which monitors an optical output of a laser light source, the optical output control circuit comprising:
a light receiver that generates a monitoring voltage according to the optical output;
a controller that obtains a set value according to the ambient temperature around the laser light source and controls the optical output of the laser light source on the basis of comparing the result between the set value and the monitoring voltage; and
an adjustor that corrects the monitoring voltage on the basis of the set value and outputs a corrected monitoring voltage.

2. The optical output control circuit according to claim 1, wherein said adjustor corrects the monitoring voltage on the basis of the set value and a reference set value according to a predetermined temperature and outputs the corrected monitoring voltage.

3. The optical output control circuit according to claim 2, wherein said adjustor includes:
an arithmetic unit that obtains the ratio of the reference set value and the set value; and
a multiplicator that multiplies the monitoring voltage by the ratio obtained by the arithmetic section and outputs the corrected monitoring voltage.

4. The optical output control circuit according to claim 1, further comprising a determinator that makes a determination as to whether or not the corrected monitoring voltage is larger than a predetermined threshold value and outputs the result of the determination.

5. The optical output control circuit according to claim 1, wherein the optical output of the laser light source includes a first optical output and a second optical output;
said light receiver receives the second optical output in the first and second optical outputs of the laser light source and generates the monitoring voltage; and
said adjustor outputs the corrected monitoring voltage as a monitoring voltage corresponding to the first optical output.

6. An optical transmitter comprising:
a laser light source; and
the optical output control circuit according to claim 1.

7. An optical output monitoring method comprising:
generating a monitoring voltage according to an optical output of a laser light source;
generating a set value according to the ambient temperature around the laser light source;
controlling the optical output of the laser light source on the basis of comparing the result comparison between the set value and the monitoring voltage; and
correcting the monitoring voltage on the basis of the set value and outputting the corrected monitoring voltage.

8. The optical output monitoring method according to claim 7, wherein the monitoring voltage is corrected on the basis of the set value and a reference set value according to a predetermined temperature, and the corrected monitoring voltage is output.

9. The optical output monitoring method according to claim 8, wherein
the ratio of the reference set value and the set value is obtained, and
the monitoring voltage is multiplied by the ratio and the corrected monitoring voltage is output.

10. The optical output monitoring method according to claim 7, wherein a determination is made as to whether or not the corrected monitoring voltage is larger than a predetermined threshold value, and the result of the determination is output.

11. The optical output monitoring method according to claim 7, wherein the optical output of the laser light source includes a first optical output and a second optical output;
the monitoring voltage is generated by receiving the second optical output in the first and second optical outputs of the laser light source; and
the corrected monitoring voltage is output as a monitoring voltage corresponding to the first optical output.
